(19) United States
(12) Patent Application Publication
(10) Pub. No.: US 2021/0165600 A1
(43) Pub. Date: Jun. 3, 2021

(54) INFORMATION PROCESSING APPARATUS, INFORMATION PROCESSING SYSTEM, AND COMPUTER-READABLE RECORDING MEDIUM RECORDING PROGRAM

(71) Applicant: FUJITSU LIMITED, Kawasaki-shi (JP)

(72) Inventor: Ken Iizawa, Yokohama (JP)

(73) Assignee: FUJITSU LIMITED, Kawasaki-shi (JP)

(21) Appl. No.: 17/092,369

(22) Filed: Nov. 9, 2020

(30) Foreign Application Priority Data
Dec. 3, 2019 (JP) 2019-218986

(51) Int. Cl. G06F 3/06

(52) U.S. Cl. CPC G06F 3/0655; G06F 3/0682; G06F 3/0604

(57) ABSTRACT

An information processing apparatus includes: a memory; and a processor coupled to the memory and configured to: perform control to write original stream data to a first sequential recording medium; perform extraction processing of first data that is at least a part of the original stream data to be written to the first sequential recording medium and is to be used in a process for analysis; and perform control to write the first data to a second sequential recording medium.

### CROSS-REFERENCE TO RELA I D APPLICATION

This application is based upon and claims the benefit of priority of the prior Japanese Patent Application No. 2019-218986, filed on Dec. 3, 2019, the entire contents of which are incorporated herein by reference.

### FIELD

The embodiment discussed herein is related to an information processing apparatus, an information processing system, and a program.

### BACKGROUND

There have been storage apparatuses or accumulating stream data that arrive in chronological order.

Japanese Laid-open Patent Publication No. 2016-5238 and Japanese Laid-open Patent Publication No. 2015-114937 are disclosed as related art.

### SUMMARY

According to an aspect of the embodiments, an information processing apparatus includes: a memory; and a processor coupled to the memory and configured to: perform control to write original stream data to a first sequential recording medium; perform extraction processing of first data that is at least a part of the original stream data to be written to the first sequential recording medium and is to be used in a process for analysis; and perform control to write the first data to a second sequential recording medium.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a table exemplifying stream data in a related example;

FIG. 2 is a diagram illustrating a write process and a read process of stream data in a related example;

FIG. 3 is a table exemplifying a recording order ape medium entries in a related example;

FIG. 4 is a block diagram schematically illustrating an exemplary configuration of an information processing system according to an exemplary embodiment;

FIG. 5 is a diagram schematically illustrating an inclusion relationship between results of a plurality of entry extraction processes and original data in the information processing system illustrated in FIG. 4;

FIG. 6 is a block diagram schematically illustrating an exemplary hardware configuration in a server illustrated in FIG. 4;

FIG. 7 is a block diagram schematically illustrating an exemplary software configuration in the server illustrated in FIG. 4; and

FIG. 8 is a flowchart illustrating a process of reading data according to an analysis job in the server illustrated in FIG. 4.

### DESCRIPTION OF EMBODIMENTS

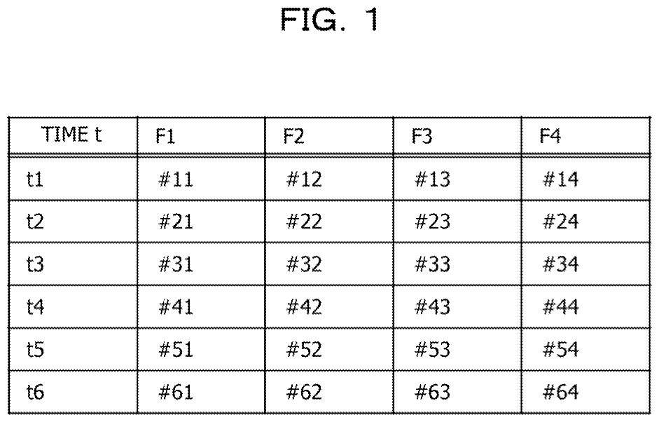

FIG. 1 is a table exemplifying stream data in a related example.

In the illustrated example, the stream data includes an entry, which is the minimum unit of stream data, for each of a plurality of fields F1 to F4 and each of times (i.e., time stamps) t1 to t6. For example, the field F1 includes entries #11, #21, #31, #41, #51, and #61 at the times t1 to t6, respectively.

Such stream data may be sensor data transmitted from a device including a plurality of sensors such as a connected car, which is an automobile connected to a server. In this case, the fields F1 to F4 illustrated in FIG. 1 correspond to the values of the respective sensors.

A stream data analysis job may be executed every unit time, and the stream data accumulated after the previous execution may be read to execute analysis such as statistical processing and machine learning. There may be a plurality of analysis jobs, and the analysis job may be set to be executed at equal intervals (e.g., one day).

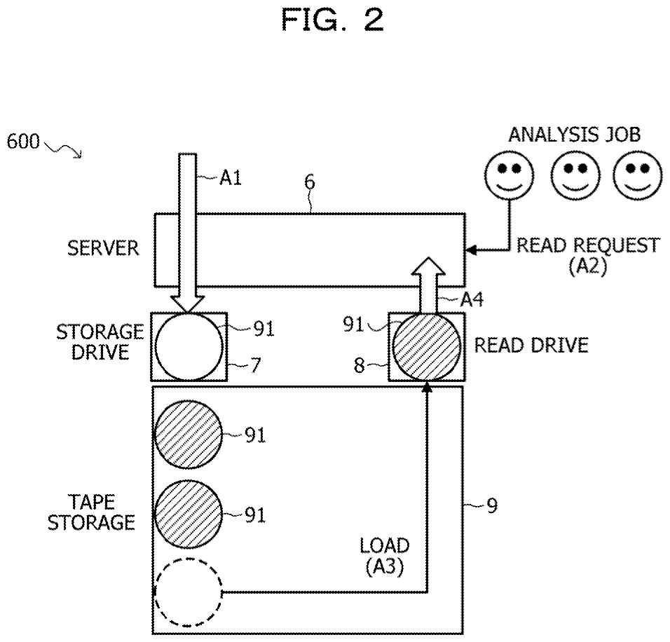

FIG. 2 is a diagram illustrating a write process and a read process of stream data in a related example.

An information processing system 600 includes a server 6, a storage drive 7, a read drive 8, and a tape medium storage 9.

The server 6 writes stream data received from a network (not illustrated) on a tape medium 91 in the storage drive 7 (see reference sign A1). When the storage area of the tape medium 91 becomes full, a new tape medium 91 is loaded into the storage drive 7, and the tape medium 91 whose storage area is full is stored in the tape medium storage 9.

Upon reception of a stream data read request based on the analysis job (see reference sign A2), the server 6 loads the tape medium 91 storing the requested unit time of data into the read drive 8 (see reference sign A3). Then, the server 6 returns the read data to the analysis job (see reference sign A4).

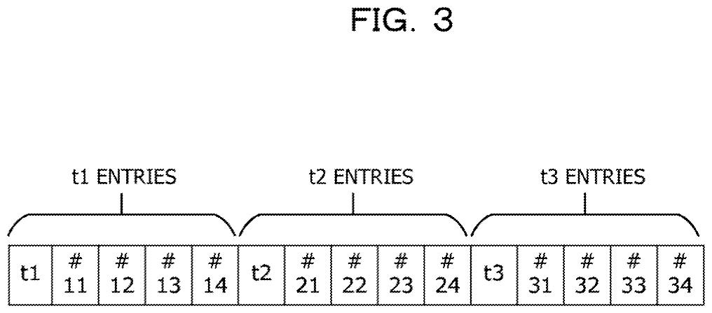

FIG. 3 is a table exemplifying a recording order of entries of the tape medium 91 in a related example.

In the tape medium 91, stream data entries are recorded in the order of entries #11 to #14 at time t1, entries #21 to #24 at time t2, and entries #31 to #34 at time t3.

Usually, only some fields of stream data are used for an analysis job. For example, a read request to extract, from the stream data at the times t1 to t2 illustrated in FIG. 1, only the fields F1 and F2 is expressed as the following structured query language (SQL) statement.

SELECT F1, F2 WHERE t>=t1 AND t<t2

Since the tape medium 91 is a medium specialized for sequential access, the server 6 actually reads all data in the tape medium 91 (i.e., all fields of the entry corresponding to the period to be analyzed). Thereafter, the server 6 extracts desirable fields from all the read fields, and then returns the extracted fields to the analysis job.

As described above, although only a part of the fields of the stream data is desired as information for the analysis job, all the fields need to be read from the tape medium 91, thereby taking a long time for reading.

In one aspect, a stream data write process in consideration of data to be used in a process for analysis may be implemented.

Hereinafter, an embodiment will be described with reference to the accompanying drawings. However, the embodiment to be described below is merely an example, and there is no intention to exclude application of various modifications and techniques not explicitly described in the embodiment. In other words, the present embodiment may be modified in a various ways to be implemented without departing from the spirit thereof.

Furthermore, each drawing is not intended to include only the constituent elements illustrated in the drawing, and may include other functions and the like.

Hereinafter, each of the same reference signs denotes a similar part in the drawings, and thus description thereof will be omitted.

### [A] Exemplary Embodiment

[A-1] Exemplary System Configuration

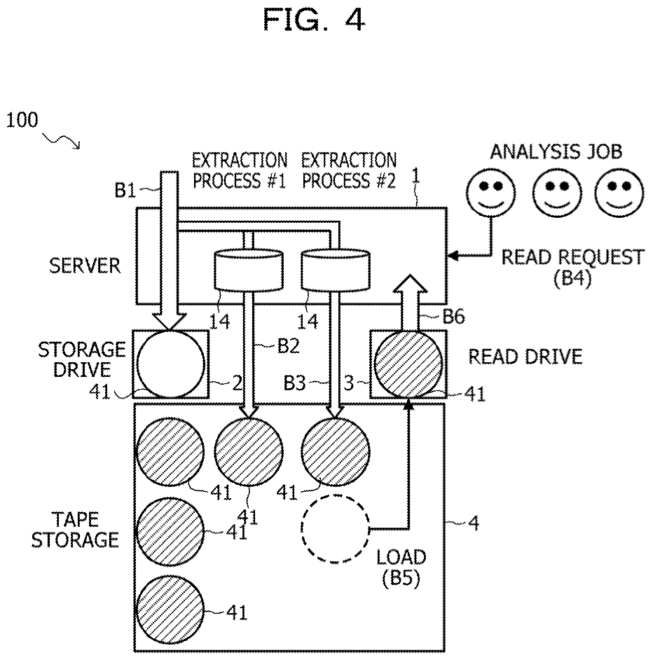

FIG. 4 is a block diagram schematically illustrating an exemplary configuration of an information processing system 100 according to an exemplary embodiment.

The information processing system 100 includes a server 1 and a storage apparatus, and the storage apparatus includes a storage drive 2, a read drive 3, and a tape medium storage 4 including a robot that stores and loads/unloads a plurality of tape media 41.

The storage drive 2 is a tape drive for accumulating stream data from the server 1 in the tape medium 41. The tape medium 41 is a magnetic sequential recording medium. The storage drive 2 and the read drive 3 are examples of sequential medium storage devices,

The read drive 3 is a tape drive for reading the stream data requested by the server 1 from the tape medium 41.

The tape medium storage 4 stores a plurality of ape media 41 for recording stream data using the storage drive 2.

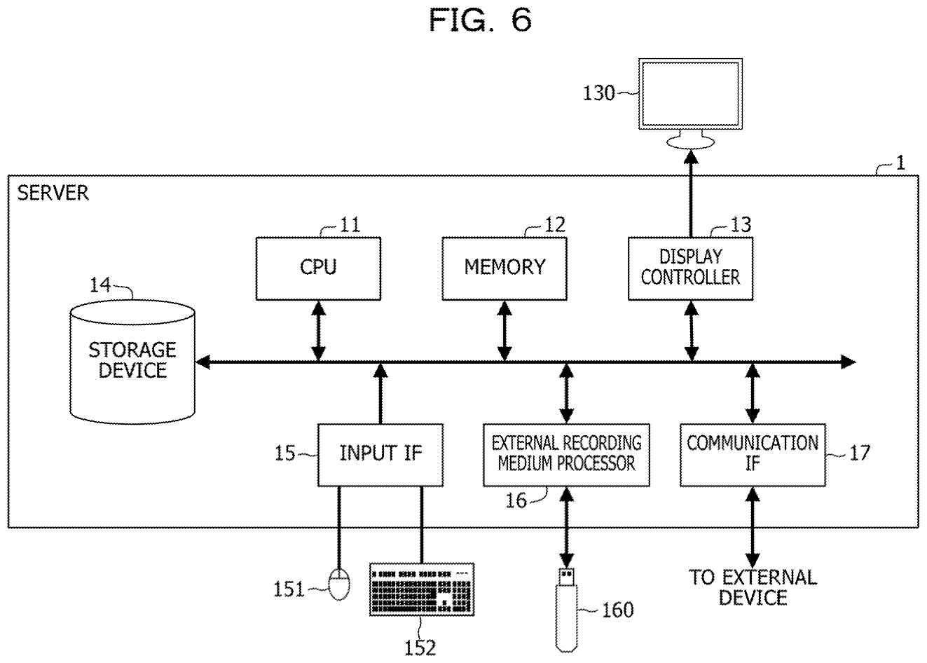

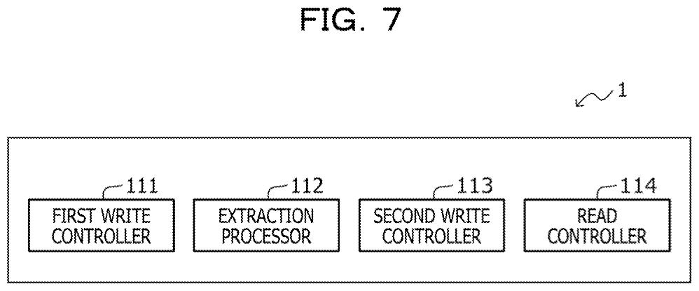

The server 1 is a computer (i.e., information processing apparatus) having a server function. The server 1 includes one or more storage devices 14. Details of the function of the server 1 will be described later with reference to, for example, FIGS. 6 and 7.

The server 1 writes stream data received from a network (not illustrated) on the tape medium 41 in the storage drive 2 (see reference sign B1). When the storage area of the tape medium 41 becomes full, the tape medium 41 is unloaded from the storage drive 2, and is stored in the tape medium storage 4. Then, a new tape medium 41 is loaded into the storage drive 7.

Furthermore, the server 1 extracts at least a part of entries (i.e., fields) of the stream data, and stores it in the storage device 14. In the illustrated example, two types of entry groups are stored in the storage device 14 as extraction processes #1 and #2. In a case where the storage area in the storage device 14 of the server 1 has become full, the data stored in the storage device 14 may be transferred to the tape medium 41, and the tape medium 41 to which the data has been transferred may be stored in the tape medium storage 4 (see reference signs B2 and B3). Since the extraction process is executed before execution of the stream data analysis job (i.e., process), it may be referred to as a pre-analysis process.

In other words, for example, the server 1 stores at least a part of the original data extracted by a predetermined extraction process in the storage device 14 while concurrently accumulating the original data in the tape medium 41. Then, when the storage area of the storage device 14 becomes full, the data stored in the storage device 14 is written to the tape medium 41. Note that the original data is compressed data or original data transmitted from the network. The data writing to the tape medium 41 from the storage device 14 may be regularly performed before the storage area of the storage device 14 becomes full, or may be performed at any time desired by a user.

Upon reception of a stream data read request based on the analysis job (see reference sign B4), the server 1 loads the tape medium 41 storing the requested entry (i.e., field) into the read drive 3 (see reference sign B5). Furthermore, the server 1 returns the read data to the analysis job (see reference sign B6).

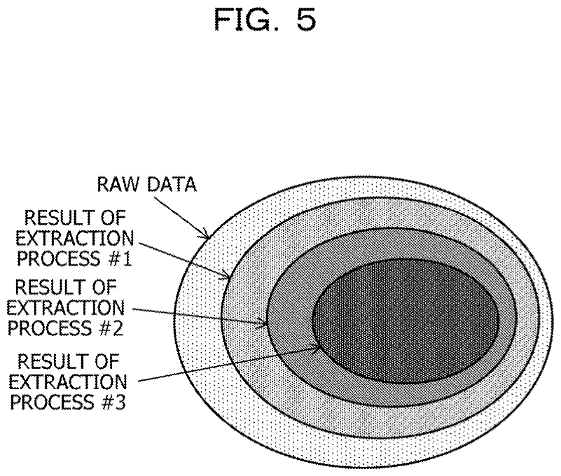

FIG. 5 is a diagram schematically illustrating an inclusion relationship between results of a plurality of entry extraction processes and the original data in the information processing system 100 illustrated in FIG. 4.

A common extraction process may be included between the stream data analysis jobs. For example, various stream data in a connected car includes car acceleration/deceleration data, the acceleration/deceleration data includes deceleration data, and the deceleration data includes deceleration data at the time of signal stoppage.

As illustrated in the drawing, the output results of the plurality of extraction processes and the original data (i.e., raw data) have an inclusion relationship. Specifically, for example, the original data includes the output result of the extraction process #1 (e.g., car acceleration/deceleration data), and the output result of the extraction process #1 includes the output result of the extraction process #2 (e.g., car deceleration data). Furthermore, the output result of the extraction process #2 includes the output result of the extraction process #3 (e.g., car deceleration data at the time of signal stoppage).

Upon reception of a read request including designation of the extraction process from the analysis job, the server 1 reads, from among a plurality of accumulated data groups having been subject to the extraction process, data with the smallest output result size among the data having been subject to the extraction process including the designated extraction process.

In the example illustrated in FIG. 5, in a case where only the original data and the result of the extraction process #3 are stored, the original data is read in response to a read request including designation of the extraction process #1. Furthermore, in a case where the original data and the results of the extraction processes #1 to #3 are stored, the result of the extraction process #2 is read in response to a read request including designation of the extraction process #2.

As described above, in a case where there are a plurality of analysis jobs, the output result of the extraction process #1 is set as data to be commonly used among the analysis jobs, whereby unnecessary reading is minimized and the reading efficiency is improved.

Note that the server 1 may select the extraction process to be executed when the stream data is accumulated on the basis of the extraction history of the extraction process.

FIG. 6 is a block diagram schematically illustrating an exemplary hardware configuration in the server 1 illustrated in FIG. 4.

As illustrated in FIG. 6, the server 1 includes a central processing unit (CPU) 11, a memory 12, a display controller 13, a storage device 14, an input interface (IF) 15, an external recording medium processor 16, and a communication IF 17.

The memory 12 is an example of a storage unit, which is, for example, a read only memory (ROM), a random access memory (RAM), and the like. Programs such as a basic input/output system (BIOS) may be written in the ROM of the memory 12. A software program of the memory 12 may be appropriately read and executed by the CPU 11. Furthermore, the RAM of the memory 12 may be used as a temporary recording memory or a working memory.

The display controller 13 is connected to a display device 130, and controls the display device 130. The display device 130 is a liquid crystal display, an organic light-emitting diode (OLED) display, a cathode ray tube (CRT), an electronic paper display, or the like, and displays various kinds of information for an operator or the like. The display device 130 may be combined with an input device, and may be, for example, a touch panel.

The storage device 14 is a storage device having high input/output (IO) performance, and for example, a hard disk drive (HDD), a solid state drive (SSD), and a storage class memory (SCM) may be used. The storage device 14 stores at least a part of the entries in the stream data. A plurality of storage devices 14 may be provided depending on the number of extraction processes executed on the stream data.

The input IF 15 may be connected to an input device such as a mouse 151 and a keyboard 152, and may control the input device such as the mouse 151 and the keyboard 152. The mouse 151 and the keyboard 152 are exemplary input devices, and the operator performs various input operations through those input devices.

The external recording medium processor 16 is configured in such a manner that a recording medium 160 can be attached thereto. The external recording medium processor 16 is configured to be capable of reading information recorded in the recording medium 160 when the recording medium 160 is attached thereto. In the present example, the recording medium 160 is portable. For example, the recording medium 160 is a flexible disk, an optical disk, a magnetic disk, a magneto optical disk, a semiconductor memory, or the like.

The communication IF 17 is an interface for enabling communication with an external device,

The CPU 11 is a processor that performs various kinds of control and calculation, and implements various functions by executing an operating system (OS) and programs stored in the memory 12.

The device for controlling operation of the entire server 1 is not limited to the CPU 11, and may be any one of an MPU, DSP, ASIC, PLD, and FPGA, for example. Furthermore, the device for controlling the operation of the entire server 1 may be a combination of two or more of the CPU, MPU, DSP, ASIC, PLD, and FPGA. Note that the MPU is an abbreviation for a micro processing unit, the DSP is an abbreviation for a digital signal processor, and the ASIC is an abbreviation for an application specific integrated circuit. Furthermore, the PLD is an abbreviation for a programmable logic device, and the FPGA is an abbreviation for a field programmable gate array.

FIG. 7 is a block diagram schematically illustrating an exemplary software configuration in the server 1 illustrated in FIG. 4.

As illustrated in FIG. 7, the server 1 functions as a first write controller 111, an extraction processor 112, a second write controller 113, and a read controller 114.

The first write controller 111 writes the original stream data on the tape medium 41 using the storage drive 2.

In other words, for example, the first write controller 111 writes the original stream data on the tape medium 41 that is a sequential recording medium.

The extraction processor 112 extracts first data that is at least a part of the original stream data to be written on the first tape medium 41 and is commonly used among a plurality of analysis jobs for analyzing the stream data.

Furthermore, the extraction processor 112 may extract, in addition to the first data, second data including at least a part of the first data.

The second write controller 113 writes at least a part of the stream data in the storage device 14 of the server 1. Furthermore, at a predetermined timing such as when the drive is free or when the storage area of the storage device 14 becomes full, the second write controller 113 causes the storage drive 2 to transfer the data of the storage device 14 to the tape medium 41. Note that, if a plurality of storage drives 2 is provided, one of the drives may be assigned to the second write controller.

In other words, for example, the second write controller 113 writes the first data extracted by the extraction processor 112 in the storage device 14.

The second write controller 113 may temporarily store the first data in the storage device 14, and then transfer the first data to a tape medium 41 different from the tape medium 41 in which the original stream data is recorded.

The second write controller 113 may write the second data including at least a part of the first data in a storage device 14 different from the storage device 14 in which the first data is recorded. Furthermore, the second write controller 113 may temporarily store the first data in the storage device 14, and then transfer the second data to a tape medium 41 different from the tape medium 41 in which the original stream data and the first data are recorded.

Therefore, the first data may be written in the storage device 14 or the tape medium 41 without affecting the write process of the original stream data, whereby the efficiency in the write process may be improved.

The read controller 114 reads data from, among a plurality of tape media 41, the tape medium 41 that contains the data related to the read request and has the smallest recorded data size.

In other words, for example, the read controller 114 reads the first data from the tape medium 41 in a case where all data used in a first analysis job are included in the first data in response to the first analysis job from among a plurality of analysis jobs.

Furthermore, the read controller 114 may read the second data from the tape medium 41 in a case where all data used in a second analysis job are included in the first data and the second data in response to the second analysis job from among a plurality of analysis jobs.

[A-2] Exemplary Operation

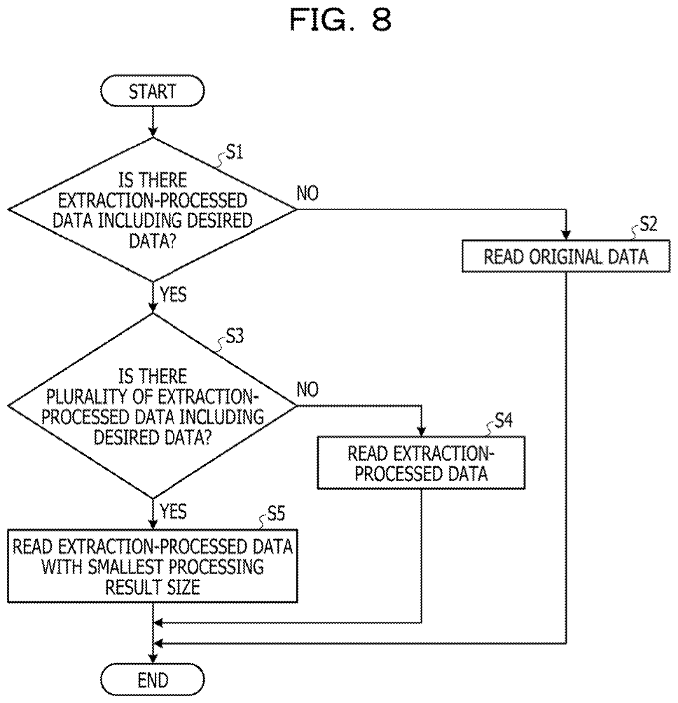

A data read process related to the analysis job in the server 1 illustrated in FIG. 4 will be described with reference to the flowchart (steps S1 to S5) illustrated in FIG. 8.

The read controller 114 determines whether the tape medium 41 in which data having been subject to the extraction process including desired data is in the tape medium storage 4 (step S1).

If there is no data having been subject to the extraction process including the desired data (see NO route in step S1), the read controller 114 reads the tape medium 41 on which the original data is recorded (step S2), and the data read process related to the analysis job is complete.

On the other hand, if there is the data having been subject to the extraction process including the desired data (see YES route in step S1), the read controller 114 determines whether a plurality of tape media 41 on which the data having been subject to the extraction process including the desired data is in the tape medium storage 4 (step S2).

If there is not more than one piece of data having been subject to the extraction process including the desired data (see NO route in step S3), the read controller 114 reads the tape medium 41 on which the data having been subject to the extraction process is recorded (step S4), and the data read process related to the analysis job is complete.

On the other hand, if there is a plurality of data having been subject to the extraction process including the desired data (see YES route in step S3), the read controller 114 reads the tape medium 41 on which the data having been subject to the extraction process with the smallest processing result size is recorded (step S5). Then, the data read process related to the analysis job is complete.

[A-3] Effect

Hereinafter, a read time V that may be reduced per unit time by performing the extraction process at the time of writing the stream data will be calculated.

The total number of the extraction processes s set to N=3, the number of the storage devices 14 included in the server 1 is set to D=1, and the ratio in size of the result of an extraction process #i to the original data is set to rᵢ (0<rᵢ<1). At this time, the read time V that may be reduced per unit time in a case where the extraction process is not performed at the time of accumulation and in a case where any of the extraction process is performed is as follows.

When no extraction process is performed (when storing only original data)

S/B*(n₁+n₂+n₃)

When performing extraction process #1

S/B*(rᵢ*nᵢ+r₁*n₂+r₁*n₃)

When performing extraction process #2

S/B*(n₁+r₂*n₂+r₂*n₃)

When performing extraction process #3

S/B*(n₁+n₂+r₃*n₃)

Note that S represents a size of the original data accumulated per unit time, B represents a read speed of the tape medium 41, and n represents the number of times the extraction process #i is executed per unit time.

V(x₁, xᵢ, . . . x_{N}) is expressed by the following formula. Note that xi=1 when the extraction process #i is performed, and xi=0 when the extraction process #i is not performed.

V(1, 0, 0)=S/B*(n₁+n₂+n₃)−S/B*(r₁*n₁+r₁*n₂+r₁*n₃)

V(0, 1, 0)=S/B*(n₁+n₂+n₃)−S/B(n₁+r₂*n₂+r₂*n₃)

V(0, 0, 1)=S/B*(n₁+n₂+n₃)−S/B*(n₁+n₂+r₃*n₃)

The set of analysis preconditions (x₁, . . . x_{N}) to be selected is obtained by solving the following optimization problem.

max V(x₁, . . . x_{N})

s.t. Σᵢrᵢ*S<=C and Σxᵢ<=D

Note that C represents the total tape capacity available for storing the extraction process results per unit time. The total size of the extraction process results generated per unit time is equal to or less than C. Furthermore, the number of extraction processes that may be executed at the time of accumulation is equal to or less than D, which is the number of the storage devices 14 included in the server 1.

For example, V is calculated under the conditions of D=1, S=200 [GB], B=200 [MB/s], C=100 [GB], (n₁, n₂, n₃)=(5, 10, 1), and (r₁, r₂, r₃)=(0.3, 0.2, 0.1).

V(1, 0, 0)=200000/200*(5+10+1)−200000/200*(0.3*5+0.3*10+0.3*1)=11200

V(0, 1, 0)=200000/200*(5+10+1)−200000/200*(5+0.2*10+0.2*1)=8800

V(0, 0, 1)=200000/200*(5+10+1)−200000/200*(5+10+0.1*1)=900

In this manner, since max V(x₁, . . . x_{N})=V(1, 0, 0)=11200, the average read performance is maximized when the extraction process #1 is selected.

In other words, for example, the extraction process selected by the method described above is performed while the stream data is being accumulated, and in response to the read request from the analysis job, the data having been subject to the extraction process is read and returned instead of the original data whenever possible. Accordingly, the average read performance of all analysis jobs may be improved.

As described above, according to the server 1, the information processing system 100, and the program described above, the following effects may be exerted, for example.

The first write controller 111 writes the original stream data on the first tape medium 41 that is a first sequential recording medium. The extraction processor 112 extracts first data that is at least a part of the original stream data to be written on the first tape medium 41 and is used in a process for analyzing the stream data. The second write controller 113 writes the extracted first data in the storage device 14 and the second tape medium 41.

Accordingly, it becomes possible to accumulate the first data concurrently with accumulation of the stream data to be successively input. When a read request is received from an analysis job that uses only a part of the original stream data, the first data extracted in advance may be directly utilized. Furthermore, the size of the first data is smaller than the original stream data, whereby the read time may be shortened. Accordingly, the start of the analysis job may be expedited.

The second write controller 113 temporarily stores the first data in the storage device 14, and then transfers the first data to a tape medium 41 different from the tape medium 41 in which the original stream data is recorded.

Accordingly, the first data may be accumulated while the stream data is being accumulated. Furthermore, the second tape medium 41 dedicated to the first data may be created. Furthermore, with the first data being temporarily stored in the storage device 14, it becomes possible to store the first data concurrently writing the original stream data on the tape medium 41. Moreover, in a similar manner to the case of reading the original stream data, a read request directed to the tape medium 41 from the analysis job may be directly utilized. Then, reading may be carried out using the read drive 3 only by changing the requested access destination from the first tape medium 41 to the second tape medium 41.

The read controller 114 reads the first data from the second tape medium 41 in a case where all data used in the first analysis job are included in the first data in response to the first analysis job from among a plurality of analysis jobs. Furthermore, in a case where all the data used in the first analysis job are not included in the first data, the read controller 114 executes the extraction process, and reads the original stream data from the first tape medium 41.

Therefore, it becomes possible to carry out a read process from the optimum tape medium 41 on which bare-minimum data are recorded. The desired data may be read efficiently. When the first data can be used in the second tape medium 41 containing a part of the original data, the time taken to obtain the data for the analysis job may be reduced.

The extraction processor 112 extracts, in addition to the first data, second data including at least a part of the first data. The second write controller 113 writes the extracted second data in a storage device 14 different from the storage device 14 in which the first data is recorded. Furthermore, the second write controller 113 temporarily stores the first data in the storage device 14, and then transfer the second data to a third tape medium 41 different from the tape medium 41 in which the original stream data and the first data are recorded.

Accordingly, it becomes possible to record the data of the plurality of extraction processing results on the respective tape media 41 in advance. If the first data and the second data are recorded on the same tape medium 41, a cueing process of the tape medium 41 needs to be performed in the case of reading the first data after reading the second data, for example. However, the first data and the second data are recorded on different tape media 41 so that the cueing process of the tape media 41 does not need to be performed, whereby the time taken to read the data may be reduced.

The read controller 114 reads the second data from the tape medium 41 in a case where all the data used in the second analysis job are included in the first data and the second data in response to the second analysis job from among a plurality of analysis jobs.

Accordingly, it becomes possible to efficiently read bare-minimum data at the time of executing the analysis job. When the second data can be used in the tape medium 41 containing a part of the original data, the time taken to obtain the data for the analysis job may be reduced.

[B] Other

The disclosed technology is not limited to the embodiment described above, and various modifications may be made without departing from the gist of the present embodiment. Each of the configurations and processes according to the present embodiment may be selected as needed, or may be combined as appropriate.

While the information processing system 100 includes the tape medium 41 as a recording medium for storing the stream data and the extraction processing results in tile exemplary embodiment described above, it is not limited thereto. The information processing system 100 may include various sequential recording media. Examples of the various sequential recording media include optical discs such as a compact disc (CD), a digital versatile disc (DVD), and a Blu-ray disc. A CD may include a CD-ROM, CD recordable (CD-R), CD rewritable (CD-RW), and the like, and a DVD may include a DVD-ROM, DVD-RAM, DVD-R, DVD+R, DVD-RW, DVD+RW, HD DVD, and the like.

As described above, the stream data and the extraction processing results are stored in the respective sequential recording media, whereby the effect of the exemplary embodiment described above may be particularly expected.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
perform control to write original stream data to a first sequential recording medium;
perform extraction processing of first data that is at least a part of the original stream data to be written to the first sequential recording medium and is to be used in a process for analysis; and
perform control to write the first data o a second sequential recording medium.

2. The information processing apparatus according to claim 1, wherein the processor:
perform the extraction processing concurrently with writing processing to the first sequential recording medium, and
perform write control for accumulating the first data in the memory and transferring the accumulated first data to the second sequential recording medium.

3. The information processing apparatus according to claim 1, wherein
the process includes a plurality of processes, and
the first data includes data commonly used in the plurality of processes

4. The information processing apparatus according to claim 1, wherein the processor:
in response to a request from a first process from among the plurality of processes, reads the first data from the second sequential recording medium in a case where all data used in the first process are included in the first data, and
reads the original stream data from the first sequential recording medium in a case where all data used in the first process are not included in the first data.

5. The information processing apparatus according to claim 1, wherein the processor:
extracts second data including at least a part of the first data, and
performs write control for accumulating the second data in the memory and transferring the accumulated second data to a third sequential recording medium.

6. The information processing apparatus according to claim 5, further wherein the processor:
in response to a request from a second process from among the plurality of processes, reads the second data from the third sequential recording medium in a case where all data used in the second process are included in the first data and the second data, and
reads the first data from the second sequential recording medium or reads the original stream data from the first sequential recording medium in a case where all data used in the second process are not included in the first data and the second data.

7. An information processing system comprising:
an information processing apparatus; and
a storage apparatus that controls access to a plurality of sequential recording media, wherein
the information processing apparatus:
performs control to write original stream data to a first sequential recording medium from among the plurality of sequential recording media;
performs extraction processing of first data that is at least a part of the original stream data to be written to the first sequential recording medium and is to be used in a process for analysis; and
performs control to write the first data to a second sequential recording medium from among the plurality of sequential recording media.

8. The information processing system according to claim 7, further comprising:
a first storage device, wherein
the information processing apparatus:
performs the extraction processing concurrently with writing processing to the first sequential recording medium, and
performs write control for accumulating the first data in the first storage device and transferring the accumulated first data to the second sequential recording medium.

9. The information processing system according to claim 7, wherein
the process includes a plurality of processes, and
the first data includes data commonly used in the plurality of processes.

10. The information processing system according to claim7, wherein the information processing apparatus:
in response to a request from a first process from among the plurality of processes, reads the first data from the second sequential recording medium in a case where all data used in the first process are included in the first data, and
reads the original stream data from the first sequential recording medium in a case where all data used in the first process are not included in the first data.

11. The information processing system according to claim 7, further comprising:
a second storage device, wherein
the information processing apparatus:
extracts second data including at least a part of the first data, and
performs write control for accumulating the second data in the second storage device and transferring the accumulated second data to a third sequential recording medium.

12. The information processing system according to claim 11, wherein the information processing apparatus:
in response to a request from a second process from among the plurality of processes, reads the second data from the third sequential recording medium in a case where all data used in the second process are included in the first data and the second data, and
reads the first data from the second sequential recording medium or reads the original stream data from the first sequential recording medium in a case where all data used in the second process are not included in the first data and the second data.

13. A non-transitory computer-readable recording medium having stored therein a program for causing a computer to execute a process comprising:
performing control to write original stream data to a first sequential recording medium;
performing extraction processing of first data that is at least a part of the original stream data to be written to the first sequential recording medium and is to be used in a process for analysis; and
performing control to write the first data to a second sequential recording medium.

14. The non-transitory computer-readable recording medium having stored therein the program according to claim 13, for causing the computer to execute the process further comprising:
performing the extraction processing concurrently with writing processing to the first sequential recording medium; and
performing write control for accumulating the first data in a first storage device and transferring the accumulated first data to the second sequential recording medium.

15. The non-transitory computer-readable recording medium having stored therein the program according to claim 13, wherein
the process includes a plurality of processes, and
the first data includes data commonly used in the plurality of processes.

16. The non-transitory computer-readable recording medium having stored therein the program according to claim 13, for causing the computer to execute the process further comprising:
in response to a request from a first process from among the plurality of processes, reading the first data from the second sequential recording medium in a case where all data used in the first process are included in the first data, and reading the original stream data from the first sequential recording medium in a case where all data used in the first process are not included in the first data.

17. The non-transitory computer-readable recording medium having stored therein the program according to claim 13, for causing the computer to execute the process further comprising:
extracting second data including at least a part of the first data; and
performing, using a second write controller, write control for accumulating the second data in a second storage device and transferring the accumulated second data to a third sequential recording medium.

18. The non-transitory computer-readable recording medium having stored therein the program according to claim 17, for causing the computer to execute the process further comprising:
in response to a request from a second process from among the plurality of processes, reading the second data from the third sequential recording medium in a case where all data used in the second process are included in the first data and the second data, and reading the first data from the second sequential recording medium or reading the original stream data from the first sequential recording medium in a case where all data used in the second process are not included in the first data and the second data.
